(19) United States
(12) Patent Application Publication
(10) Pub. No.: US 2021/0366026 A1
(43) Pub. Date: Nov. 25, 2021

(54) VENDING MACHINE, VENDING METHOD AND ADVANCED PRODUCT RECOMMENDATION ENGINE FOR VENDING MACHINES

(71) Applicant: lnvenda Group AG, Luzern (CH)

(72) Inventors: Jon Raymond Brezinski, Engelberg (CH); Srdjan Poznic, Novi Sad (RS); Karl Jonatan Brzezinski, Stockholm (SE); Jelena Novakovlc, Novi Sad (RS)

(73) Assignee: lnvenda Group AG, Luzern (CH)

(21) Appl. No.: 17/327,985

(22) Filed: May 24, 2021

Related U.S. Application Data
(60) Provisional application No. 63/029,483, filed on May 24, 2020.

(51) Int. Cl. G06Q 30/06; G06Q 20/18

(52) U.S. Cl. CPC G06Q 30/0631; G06Q 20/18

(57) ABSTRACT

Vending machine, vending method and advanced product recommendation engine for vending machines are disclosed.

### CROSS-REFERENCE TO RELATED APPLICATIONS

This application claims priority to U.S. Provisional Application No. 63/029,483 filed on May 24, 2020, which is incorporated herein reference in its entirety,

### FIELD OF THE INVENTION

The present invention relates to the field of vending machines and, more particularly, to advanced product recommendation engine for vending machines.

### BACKGROUND OF THE INVENTION

Operators of vending machines may look to increase the value and number of transactions on their vending machines in order to maximize revenue. Multiple-product transaction vending machines have, increased the number of products sold per transaction, but their effect is limited as compared to advanced product recommendation systems, such as web-based product recommendation systems. More targeted product recommendations on vending machines may maximize the revenue thereof.

### SUMMARY OF THE INVENTION

Some embodiments of the present invention may provide a vending machine, which vending machine may include: a user interface; an environment data module configured to obtain an environment data indicative at least of an ambient temperature and a weather in a vicinity of the vending machine; a setting data module configured to obtain a setting data indicative at least of a location of the vending machine and demographic profile of users in a vicinity of the vending, machine; and a dynamic product recommendation module configured to: determine one or more recommendations concerning one or more product to a user based on at least one of the environmental data and the setting data, and present the one or more recommendations to the user using the user interface.

In some embodiments, the vending machine may include a user data module configured to at least one of: detect a user approaching the vending machine, and obtain as user data indicative of at least one property of the user, and wherein the dynamic product recommendation module is configured to determine the one or more recommendations further based on the user data.

In some embodiments, the vending machine may include a time data module configured to obtain a time data, and wherein the dynamic product recommendation module is configured to determine the one or more recommendations further based on the time data.

In some embodiments, the dynamic product recommendation module is configured to determine the one or more recommendations using a dynamic product recommendation model predefined based on a history of transaction datasets.

In some embodiments, each of the transaction datasets comprises one or more products sold during respective transaction linked with at least one of respective environmental data and respective setting data and optionally with at least one of respective user data and respective time data.

In some embodiments, the dynamic product recommendation module is configured to determine the one or more recommendations before the user has selected one or more items to purchase.

In some embodiments, the dynamic product recommendation module is configured to determine the one or more recommendations after the user has selected one or more items to purchase.

In some embodiments, the dynamic product recommendation module is configured to determine the one or more recommendations further based on the selected one or more items.

In some embodiments, the dynamic product recommendation module is configured to update the dynamic product recommendation model based on current transaction dataset.

In some embodiments, the vending machine may include a back-end management interface configured to enable an operator of the vending machine to perform at least one of: manage a vending machine configuration data; manage a static product recommendation list; and enable and disable the dynamic product recommendation module.

In some embodiments, the dynamic product recommendation module is configured to determine the one or more recommendations further based on at least one of: the vending machine configuration data; and the static product recommendation list.

In some embodiments, the vending machine may include a tracking module configured to track a surrounding of the vending machine and generate a tracked data indicative of an amount of people walking past the vending machine and the demographic profiles thereof; wherein the dynamic product recommendation module is configured to determine the one or more recommendations further based the tracked data.

Some embodiments of the present invention may provide a vending method, which vending method may include: obtaining, by a vending machine, an environment data indicative at least of an ambient temperature and a weather in a vicinity of the vending machine; obtaining, by the vending machine, a setting data indicative at least of a location of the vending machine and demographic profile of users in a vicinity thereof; determining, by the vending machine, one or more recommendations concerning one or more product to a user based on at least one of the environmental data and the setting data; and presenting the one or more recommendations to the user using the user interface.

Some embodiments may include at least one of: detecting, by the vending machine, a user approaching the vending machine; obtaining, by the vending machine, a user data indicative of at least one property of the user; and determining, by the vending machine, the one or more recommendations further based on the user data.

Some embodiments may include obtaining, by the vending machine, a time data; and determining, by the vending machine, the one or more recommendations further based on the time data.

Some embodiments may include determining the one or more recommendations using a dynamic product recommendation model predefined based on a history of transaction datasets.

In some embodiments, each of the transaction datasets comprises one or more products sold during respective transaction linked with at least one of respective environmental data and respective setting data and optionally with at least one of respective user data and respective time data.

Some embodiments may include determining the one or more recommendations before the user has selected one or more items to purchase.

Some embodiments may include determining the one or more recommendations after the user has selected one or more items to purchase.

Some embodiments may include determining the one or more recommendations further based on the selected one or more items.

Some embodiments may include updating the dynamic product recommendation model based on current transaction dataset.

Some embodiments may include at least one of managing a vending machine configuration data; and managing a static product recommendation list.

Some embodiments may include determining the one or more recommendations further based on at least one of: the vending machine configuration data and static product recommendation list.

Some embodiments may include tracking, by the vending machine, a surrounding of the vending machine and generating a tracked data indicative of an amount of people walking past the vending machine and the demographic profiles thereof; and determining the one or more recommendations further based the tracked data.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1 is a block diagram of a vending machine, according to some embodiments of the invention; and

FIG. 2 is a flowchart of a vending method, according to some embodiments of the invention.

It will be appreciated that, for simplicity and clarity of illustration, elements shown in the figures have not necessarily been drawn to scale. For example, the dimensions of sonic of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units can be at least partially implemented by a computer processor.

Various embodiments of the present invention provide a vending machine, a vending method and a dynamic product recommendation model.

The vending machine may, for example, be a multiple-product transaction vending machine. The vending machine may include a user interface module. The user interface module may be configured to receive a selection of one or more products from a user.

The vending machine may include an environment data module configured to obtain environmental data in a vicinity of the vending machine. The environmental data may, for example, include weather, temperature, etc. The vending machine may include a setting data module configured to obtain setting data in a vicinity of the vending machine. The setting data may, for example, include a location of the vending machine (e.g., city, village, train station, street, etc.), demographic profile of users and typical user behavior in at vicinity of the location, visibility of an advertising screen of the vending machine (e.g., across a whole arrival hall vs. behind a pillar, along a platform, etc.) or competition details in the area (e.g., alternative machines or shops in the area, etc.), etc.

The system may include a dynamic product recommendation module. The dynamic product recommendation module may determine one or more recommendations concerning one or more products for the user based on a least one of the environmental data and the setting data and optionally based on at last one of a user data (e.g., indicative of at least one property of a user such as age, gender, etc.), a time data (e.g., weekday, time of a day, season of a year, etc.) and product(s) selected by the user. The dynamic product recommendation module may present the one or more recommendations to the user via the user interface. In some embodiments, the dynamic product recommendation module may determine the one or more recommendations using a dynamic product recommendation model. The dynamic product recommendation model may, for example, implement one or more machine learning techniques. The dynamic product recommendation model may be constructed based on a history of transaction datasets (e.g., collected from different vending machines). Each of the transaction datasets may include one or more products sold during respective transaction linked, with respective environmental data, respective setting data and optionally with at least one of respective user data and respective time data. In some embodiments, the dynamic product recommendation model may be constructed at a remote computing device and loaded onto the dynamic product recommendation module once the model ready.

Advantageously, the dynamic product recommendation model may take into account the environmental data, the setting data and optionally at least one of the user data, the time data and the product(s) selected by the user when determining the recommendation(s). This may, for example, enable the vending machine to recommend more targeted products to the user as compared to current vending machines, as the recommendations are suited to the user, the environment and the setting the user is in at the time of sale.

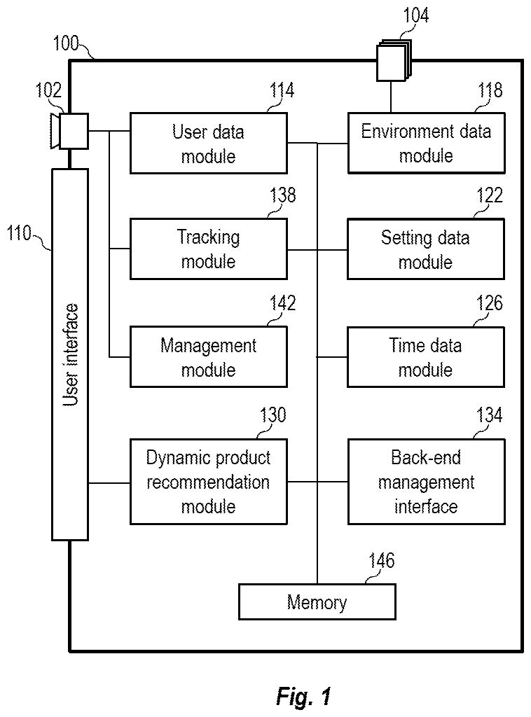

Reference is now made to FIG. 1, which is a block diagram of a vending machine 100, according to some embodiments of the invention.

Vending machine 100 may be, for example, a multiple-product transaction vending machine. Vending machine 100 may include a user interface 110. In some embodiments, user interface 110 may include a display and one or more input devices. In some embodiments, user interface 110 may include a touch screen. User interface 110 may be configured to receive a selection of one or more products front a user.

In some embodiments, vending machine 100 may include a user data module 114. User data module 114 may detect that a user approaches vending machine 100. User data module 114 may obtain a user data indicative of at least one property of a user. The at least one property may, for example, include an age, a gender of the user. Other examples of the at least one property may include emotions, height, gadgets wearable by the user (e.g., glasses, hat, headphones, etc.), facial hair, etc. For example, vending machine 100 may include a camera 102. Camera 102 may obtain one or more images of at least a portion of the user approaching vending machine 100. User data module 114 may, for example, determine the age, gender, height of the user, gadgets wearable by the user, etc. based on the image(s) thereof. In some embodiments, user data module 114 may detect multiple users shopping together. For example, user data module 114 may detect multiple faces looking the vending machine at the same time. In this case, the user data obtained may be indicative of one or more properties of at least some of the multiple users.

In some embodiments, vending machine 100 may include an environment data module 118. Environment data module 118 may obtain environmental data in a vicinity of vending machine 100. The environmental data may, for example, include weather, temperature, etc. For example, vending machine 100 may include one or more sensors 104 (e.g., temperature sensor, pressure sensor, wind sensor, etc.) and environment data module 118 may be configured to generate the environmental data based on readings of sensor(s) 104. In another example, environmental data module 118 may obtain the environmental data from an external server.

In some embodiments, vending machine 100 may include a setting data module 122. Setting data module 122 may obtain a setting data in a vicinity of vending machine 100. The setting data may, for example, include a location of the vending machine e.g., city, village, train station, street, etc.), demographic profile of the users in a vicinity of the location, typical user behavior in a vicinity of the location, visibility of an advertising screen of vending machine 100 (e.g., across a whole arrival hall vs. behind a pillar, along a platform, etc.) or competition details in the area (e.g., alternative machines or shops in the area, etc.), etc. Setting data module 122 may obtain the setting data, or portions thereof, from, for example, one or more external sources and/or using, at least some of sensors of vending machine 100. The external sources stay, for example, include remote servers that may be accessed by setting data module 120. In another example, the setting data, or a portion thereof, may be loaded onto setting data module 120 during installation of vending machine 100.

For example, setting data module 122 may receive the location of vending machine 100 as an input during the installation of vending machine 100 or vending machine 100 may include a geolocation sensor for determining the location thereof. In another example, the location may be obtained from an external source such as mobile network, etc.

In some embodiments, setting data module 122 may extract at least a portion of the setting data from images obtained from camera 102. For example, some location details, such as a distance to the closest object in front of vending machine 100 and/or a distance to the user inform of vending machine 100, may be determined by setting data module 120 based on images from camera 102.

The demographic profile of the users and typical user behavior in a vicinity of the location may be obtained by setting data module 122 from, for example, an external source such as a remote server that may be accessed by setting data module 122. In another example, such data may be loaded onto setting data module 122 during installation of vending machine 100.

In another example, the users of vending machine 100 may have an application running on their mobile devices (e.g., smartphones, etc.). In this case, setting data module 122 may connect to the application of the user approaching vending machine 100 and obtain user-specific information from the application. The user-specific information may, for example, include demographic profile of the particular user and/typical user behavior/preferences thereof.

In some embodiments, vending machine 100 may include a time data module 126. Time data module 126 may obtain a time data. The time data may, for example, include a weekday, time of the day, time of the year, etc. For example, time data module 126 may obtain the time data from an external server and/or from an internal clock of vending machine 100 that runs when, for example vending machine is offline.

In some embodiments, vending, machine 100 may include a dynamic product recommendation module 130. Dynamic product recommendation module 130 may determine one or more recommendations for the user concerning one or more products based on at least one of the environmental data (e.g., weather, temperature, etc.) and the setting data (e.g., location, demographic profile and typical user behavior in a vicinity of the location, etc.). Dynamic product recommendation module 130 may present, or highlight, the one or more determined recommendations to the user via user interface 110.

Determining the one or more recommendations for the user based on the environmental data and the setting data may, for example, result in more targeted products recommendations as compared to current vending machines, as the recommendations are suited to the environment (e.g., weather, temperature, etc.) and the setting (e.g., the location, the demographic profile, typical user behavior in a vicinity of the location, etc.) the user is in at the time of sale. For example, at relatively low ambient temperatures and/or rainy weather, dynamic product recommendation module 130 may recommend hot drinks, while at relatively high temperatures and/or sunny weather dynamic product recommendation module 130 may recommend cold drinks. In another example, dynamic product recommendation module 130 may recommend products of a first type/group when vending machine 100 is located at a train station and products of a second type/group when vending machine 100 is located in street. In another example, dynamic product recommendation module 130 may recommend products of a third type/group for users of a first demographic profile and products of a fourth type/group for users of a second demographic profile.

In some embodiments, dynamic product recommendation module 130 may determine the one or more recommendations for the users concerning the one or more products further based on the user data (e.g., age, gender of the user, etc.). For example, dynamic product recommendation module 130 may recommend products of a fifth type/group to adult users and products of a sixth type/group to teenagers.

In some embodiments, dynamic product recommendation module 130 may determine the one or more recommendations concerning the one or more products further based on the time data (e.g., a weekday, time of the day, time of the year). For example, dynamic product recommendation module 130 may recommend products of a seventh type/group on Saturdays, products of an eighth type/group during morning; hours and products of a ninth type group during evening hours, etc.

In some embodiments, dynamic product recommendation module 130 may determine the one or more recommendations concerning the one or more products using a dynamic product recommendation model. The dynamic product recommendation model may, for example, implement one or more machine teaming techniques. The dynamic product recommendation model may be constructed based on a history of transaction datasets (e.g., collected from different vending machines). Each of the transaction datasets may include one or more products sold during respective transaction linked with, respective environmental data, respective setting data and optionally with at least one of respective user data and respective time data. In some embodiments, the dynamic product recommendation model may be constructed at a remote computing device and loaded onto dynamic product recommendation module 130 of vending machine 100 once the model is ready.

In some embodiments, dynamic product recommendation module 130 may determine the one or more recommendations before the user has selected one or more items to purchase. For example, user data module 114 may detect that a user approaches vending machine 100. Dynamic product recommendation module 130 may determine the one or more recommendations concerning the one or more products before the user selects item(s), based on the environmental data, the setting data and optionally based on at least one of the user data and the time data and present the recommendation(s) thereof using user interface 110. In some embodiments, dynamic product recommendation module 130 may update the recommendation(s) based on the selected item(s) and present the updated recommendation(s) using user interface 110. In some embodiments, dynamic product recommendation module 130 may determine the recommendation(s) after the user has selected the item(s) to purchase e.g., via user interface 110). In some embodiments, dynamic product recommendation module 130 may determine the recommendation(s) further based on the selected item(s).

In some embodiments, dynamic product recommendation module 130 may update the dynamic product recommendation model based on current transaction dataset. The current transaction dataset may, for example include, product(s) bought during current transaction, current environmental data, current setting data, and optionally at least one of current user data and current time data.

In some embodiments, vending machine 100 may include a back-end management interface 134. In various embodiments, back-end management interface 134 may enable an operator of vending machine 100 to define and/or change vending machine configuration data. The vending machine configuration data may, for example, include at least one of: a number of products on offer, types of products on offer, diversity of products on offer, products pricing points, current promotions, length of transaction, allowable number of products per transaction, enabled/disabled viewing of product ingredients/description/nutritional information, timeouts, allowable payment types, advertisements playing, transaction end state, etc. In some embodiments, dynamic product recommendation module 130 may determine the one or more recommendations concerning the one or more products for the user further according to the vending machine configuration data.

For example, if the operator/owner of vending machine 100 wants to run a promotion on the vending machine, they can lower the price of a product, directly and/or update the price in real time, or they could choose to put that product as the main recommended product. Similarly, if a product is physically available in the vending machine, but the operator/owner no longer wishes to vend it, the product can be blocked from selection for users and thus no longer visible on user interface 110. By combining recommended products with offered products it is possible to avoid the situation where recommended products are not present in the vending machine.

In various embodiments, back-end management interface 134 may enable the operator of vending machine 100 to link different products to define and/or update a static product recommendation list. In some embodiments, dynamic product recommendation module 130 may determine the one or more recommendations concerning the one or more products for the user further based on the static product recommendation list. For example, if dynamic product recommendation module 130 recommends a specific product to the user based on the environmental data and the setting data, it may also recommend one or more additional products linked to the specific product as defined by the static product recommendation list.

In some embodiments, back-end management interface 134 may enable the operator of vending machine 100 to enable and disable dynamic product recommendation module 130. In some embodiments, back-end management interface 134 may enable wireless connection of the operator thereto.

In some embodiments, vending machine 100 may include a tracking module 138. Tracking module 138 may track a surrounding of vending machine 100 and generate a tracked data. In various embodiments, tracking module 138 may count people walking past Vending machine 100 and/or determine demographic profiles of the people thereof (e.g., based on images captured by camera 102). Tracking module 138 may generate the tracked data indicative of the information being tracked. In some embodiments, dynamic product recommendation module 130 may determine the one or more recommendations for the user further based on the tracked data. For example, dynamic product recommendation module 130 may adjust the one or more recommendations according to the number of people walking past vending machine and/or according to the demographic profiles thereof.

In some embodiments, vending machine 100 may include a vending machine management module 142. In some embodiments, vending machine management module 142 may manage biometric payment. For example, vending machine management module 142 may enable dispensing products selected by the user by approving payment through facial recognition of the user (e.g., made based on image(s) captured by camera 102), finger print and/or hand vein recognition technology.

In some embodiments, vending machine management module 142 may manage age verification of the user. For example, vending machine management module 142 may confidently verify the age of the user (e.g., by capturing an identification document of the user by camera 102) in order to verify that product(s) selected by the user meet the requirements of age restricted products.

In some embodiments, vending machine management module 142 may manage a predictive maintenance of vending, machine 100. For example, vending machine management module 142 may monitor the life cycle of different components of vending machine 100 and/or and recommend replacement of some components when required.

In some embodiments, vending machine management module 142 may manage a smart refilling routing. For example, vending machine management module 142 may suggest most efficient routing for merchandisers based on current inventory, predicted sales and location of vending machine 100. In another example, vending machine management module 142 may be linked with a calendar with events in a vicinity of vending machine 100 to warn operators to fill the vending machine ahead of events in the area.

In some embodiments, vending machine 100 may include a memory 146. Memory 146 may store at least one of: the user data, the environmental data, the setting data, the time data, the vending machine configuration data, the static product recommendation list, the tracking data, the history of transactions datasets, etc.

It is noted that each module in vending, machine 100 may be implemented on its own computing device, a single computing device, or a combination of computing devices. The communication between the modules of vending machine 100 may be wired and/or wireless.

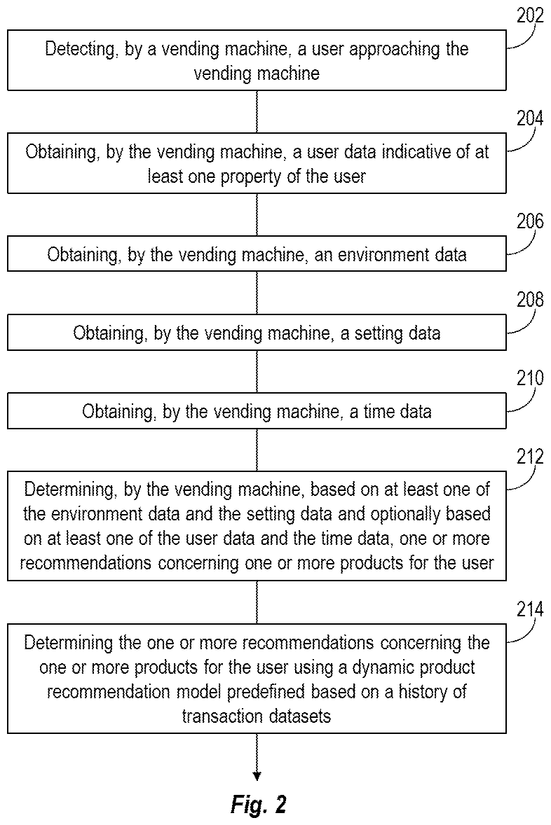

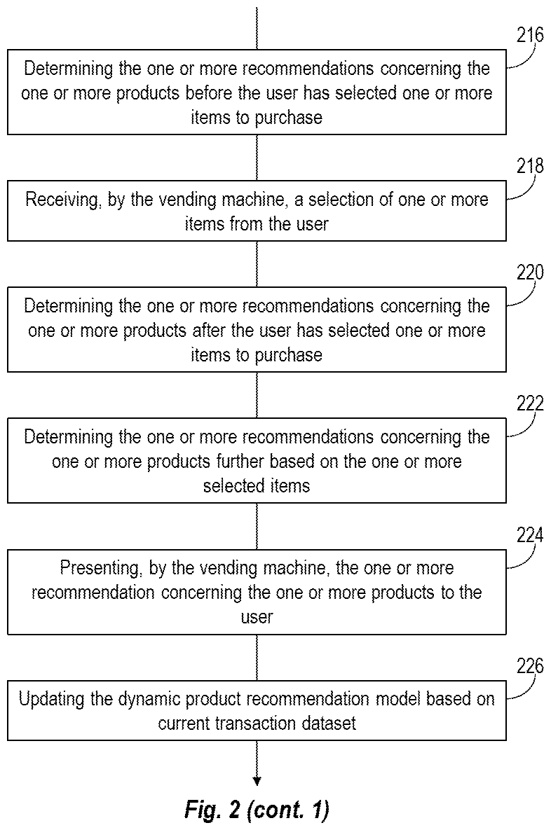

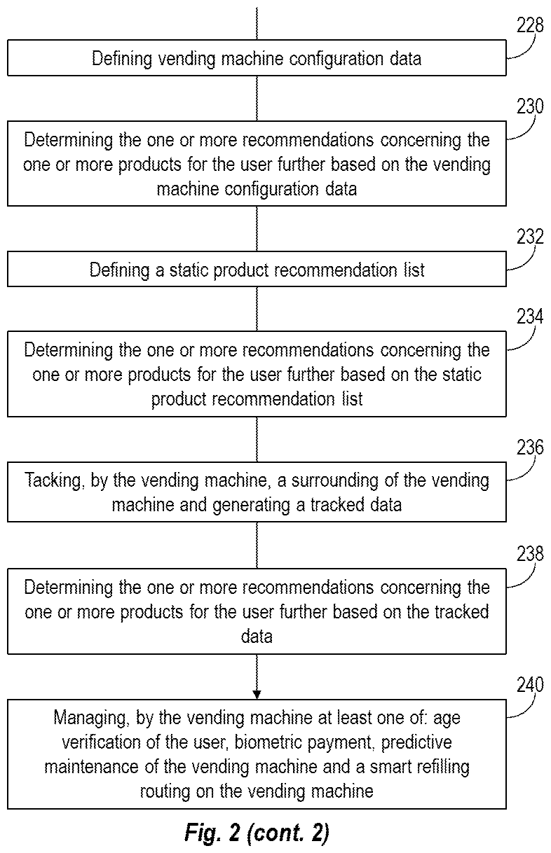

Reference is now made to FIG. 2, which is a flowchart of a vending method, according to some embodiments of the invention.

The method may be implemented by, for example, a vending machine such as vending. machine 100 described above with respect to FIG. 1. It is noted that the method is not limited to the flowcharts illustrated in FIG. 2 and to the corresponding description. For example, in various embodiments, the method need not move through each illustrated box or stage, or in exactly the same order as illustrated and described.

Some embodiments may include detecting, by a vending machine, a user approaching the vending machine (stage 202). For example, the detection may be made based on one or more images obtained by a camera of the vending machine, as described above with respect to FIG. 1.

Some embodiments may include obtaining, by the vending machine, a user data indicative of at least one property of the user (stage 204). For example, the at least one property may include, for example, an age, gender, emotions, height of the user and/or gadgets wearable by the user, etc. of the user. The at least one property of the user may be determined based on, for example, image(s) captured by the camera, as described above with respect to FIG. 1.

Some embodiments may include obtaining, by a vending machine, an environment data (stage 206). The environmental data may, for example, include weather, temperature, etc. in a vicinity of the vending machine. The environmental data may be obtained using, for example, sensors and/or from an external server, as described above with respect to FIG. 1.

Some embodiments may include obtaining, by the vending machine, a setting data (stage 208). The setting data may, for example, include a location of the vending machine (e.g., city, village, train station, street, etc.), demographic profile of the users in a vicinity of the location and typical user behavior in a vicinity of the location, visibility of an advertising screen of vending machine 100 (e.g., across a whole arrival hall vs. behind a pillar, along a platform, etc.) or competition details in the area (e.g., alternative machines or shops in the area, etc.), etc.

Some embodiments may include obtaining, by the vending machine, a time data (stage 210). The time data may, for example, include a weekday, time of the day, time of the year, etc. For example, the time data may be obtained from an external server and/or front an internal clock of the vending machine that runs when, for example vending machine is offline.

Some embodiments may include determining, by the vending machine, based on at least one of the environment data and the setting data and optionally based on at least one of the user data and the time data, one or more recommendations concerning one or more products for the user (stage 212). For example, as described above with respect to FIG. 1.

Some embodiments may include determining the one or more recommendations concerning the one or more products for the user using a dynamic product recommendation model predefined based on a history of transaction datasets (stage 214). Each of the transaction datasets may include one or more products sold during respective, transaction linked with, at least one of respective environmental data, respective setting data and optionally with at least one of respective user data and respective time data (e.g., as described above with respect to FIG. 1).

Some embodiments determining the one or more recommendations concerning the one or more products before the user has selected one or more items to purchase (stage 216).

Some embodiments may include receiving, by the vending machine, a selection of one or more items from the user (stage 218). For example, the selection may be received using a vending machine's user interface, as described above with respect to FIG. 1.

Some embodiments may include determining the one or more recommendations concerning the one or more products after the user has selected one or more items to purchase (stage 220).

Some embodiments may include determining the one or more recommendations concerning the one or more products further based on the one or more selected items (stage 222).

Some embodiments may include presenting, by the vending machine, the one or more recommendation concerning the one or more products to the user (stage 224). For example, the recommendation(s) may be presented using, the vending machine's user interface as described above with respect to FIG. 1.

Some embodiments may include updating the dynamic product recommendation model based on current transaction dataset (stage 226). The current transaction dataset may, for example include, product(s) bought during current transaction, current environmental data, current setting data, and optionally at least one of current user data and current time data (e.g., as described above with respect to FIG. 1).

Some embodiments may include defining vending machine configuration data (stage 228). The vending machine configuration data may, for example, include at least one of: a number of products on offer, types of products on offer, diversity of products on offer, products pricing points, current promotions, length of transaction, allowable number of products per transaction, enabled/disabled viewing of product ingredients/description/nutritional information, timeouts, allowable payment types, advertisements playing, transaction end state, etc.

Some embodiments may include determining the one or more recommendations concerning the one or more products for the user further based on the vending machine configuration data (stage 230).

Some embodiments may include defining a static product recommendation list (stage 232). For example, the static product recommendation list may be defined by linking different products on offer, as described above with respect to FIG. 1.

Some embodiments may include determining the one or more recommendations concerning the one or more products for the user further based on the static product recommendation list (stage 234).

Some embodiments may include tracking, by the vending machine, a surrounding of the vending machine and generating a tracked data (stage 236). For example, the tracking may include counting people walking past the vending machine and/or determining demographic profiles thereof (e.g., as described above with respect to FIG. 1).

Some embodiments may include determining the one or more recommendations concerning the one or more products for the user further based on the tracked data (stage 238). For example, as described above with respect to FIG. 1.

Some embodiments may include managing, by the vending machine at least one of: age verification of the user, biometric payment, predictive maintenance of the vending machine and a smart refilling routing on the vending machine (stage 240).

The disclosed vending machine and vending method may utilize a dynamic product recommendation model that may take into account the environmental data, the setting data and optionally at least one of the user data, the time data and the product(s) selected by the user when determining the recommendation(s). This may, for example, enable the vending machine to recommend more targeted products to the user as compared to current vending machines, as the recommendations are suited to the user, the environment and the setting the user is in at the time of sale.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart, and/or portion diagram portion or portions thereof. The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams can represent a module, segment, or portion of code, which includes one or more executable instructions for implementing the specified logical function(s). It should also be noted that, in some alternative implementations, the functions noted in the portion can occur out of the order noted in the figures. For example, two portions shown in succession can, in fact, be executed substantially concurrently, or the portions can sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A vending machine comprising:
a user interface;
an environment data module configured to obtain an environment data indicative at least of an ambient temperature and a weather in a vicinity of the vending machine;
a setting data module configured to obtain a setting data indicative at least of a location of the vending machine and demographic profile of users in a vicinity of the vending machine; and
a dynamic product recommendation module configured to:
determine one or more recommendations concerning one or more product to a user based on at least one of the environmental data and the setting data, and
present the one or more recommendations to the user using the user interface.

2. The vending machine of claim 1, further comprising a user data module configured to at least one of:
detect a user approaching the vending machine, and
obtain a user data indicative of at least one property of the user;
wherein the dynamic product recommendation module is configured to determine the one or more recommendations further based on the user data.

3. The vending machine of claim 1, further comprising a time data module configured to obtain a time data, and wherein the dynamic product recommendation module is configured to determine the one or more recommendations further based on the time data.

4. The vending machine of claim 1, wherein the dynamic product recommendation module is configured to determine the one or more recommendations using a dynamic product recommendation model predefined based on a history of transaction datasets.

5. The vending machine of claim 4, wherein each of the transaction datasets comprises one or more products sold during respective transaction linked with at least one of respective environmental data and respective setting data and optionally with at least one of respective user data and respective time data.

6. The vending machine of claim 1, wherein the dynamic product recommendation module is further configured to determine the one or more recommendations before the user has selected one or more items to purchase.

7. The vending machine of claim 1, wherein the dynamic product recommendation module is further configured to determine the one or more recommendations after the user has selected one or more items to purchase.

8. The vending machine of claim 7, wherein the dynamic product recommendation module is further configured to determine the one or more recommendations further based on the selected one or more items.

9. The vending machine of claim 4, wherein the dynamic product recommendation module is further configured to update the dynamic product recommendation model based on current transaction dataset.

10. The vending machine of claim 1, further comprising:
a tracking module configured to truck a surrounding of the vending machine and generate a tracked data indicative of an amount of people walking past the vending machine and the demographic profiles thereof;
wherein the dynamic product recommendation module is configured to determine the one or more recommendations further based the tracked data.

11. A vending method comprising:
obtaining, by a vending machine, an environment data indicative at least of an ambient temperature and a weather in a vicinity of the vending machine;
obtaining, by the vending machine, a setting data indicative at least of a location of the vending machine and demographic profile of users in a vicinity thereof;
determining, by the vending machine, one or more recommendations concerning one or more product to a user based on at least one of the environmental data and the setting data; and
presenting the one or more recommendations to the user using the user interface.

12. The method of claim 1, further comprising at least one of;
detecting, by the vending machine, a user approaching the vending machine;
obtaining, by the vending machine, a user data indicative of at least one property of the user; and
determining, by the vending machine, the one or more recommendations further based on the user data.

13. The method of any one of claim 11, further comprising:
obtaining, by the vending machine, a time data; and
determining, by the vending machine, the one or more recommendations further based on the time data.

14. The method of claim 11, further comprising determining the one or more recommendations using a dynamic product recommendation model predefined based on a history of transaction datasets.

15. The method of claim 14, wherein each of the transaction datasets comprises one or more products sold during respective transaction linked with at least one of respective environmental data and respective setting data and optionally with at least one of respective user data and respective time data.

16. The method of claim 11, further comprising determining the one or more recommendations before the user has selected one or more items to purchase.

17. The method of claim 11, further comprising determining the one or more recommendations after the user has selected one or more items to purchase.

18. The method of claim 17, further comprising determining the one or more recommendations further based on the selected one or more items.

19. The method of claim 14, further comprising updating the dynamic product recommendation model based on current transaction dataset.

20. The method of claim 11, further comprising:
tracking, by the vending machine, a surrounding, of the vending, machine and generating a tracked data indicative of an amount, of people walking past the vending machine and the demographic profiles thereof; and
determining the one or more recommendations further based the tracked data.
